(19) United States
(12) Patent Application Publication
(10) Pub. No.: US 2006/0204713 A1
(43) Pub. Date: Sep. 14, 2006

(54) Mat

(76) Inventors: Trijntje Agnita Zuiddam-Bood, Putten (NL); Evert Zuiddam, Putten (NL)

Correspondence Address: YOUNG & THOMPSON, 745 SOUTH 23RD STREET, 2ND FLOOR, ARLINGTON, VA, 22202, US

(21) Appl. No.: 11/369,951

(22) Filed: Mar. 8, 2006

(30) Foreign Application Priority Data
Mar. 8, 2005 (NL) 1028489
Mar. 9, 2005 (NL) 1028503

(51) Int. Cl. B32B 3/06

(52) U.S. Cl. 428/104

(57) ABSTRACT

Mat with a tread area for cleaning foot-wear of individuals walking over the mat, comprising a series of longitudinal profiles, formed by extrusion, which are disposed in parallel, which are each provided with an accommodation recess for accommodating a tread area member, such as a brush, furthermore comprising one or more coupling profiles, extending substantially transversely to the longitudinal profiles and comprising first connection means for connection with the longitudinal profiles, wherein two coupling profiles are arranged for respective connection with the longitudinal ends of the longitudinal profiles, and also comprising confining profiles extending along said two coupling profiles, wherein the two coupling profiles and the associated confining profiles are provided with second and third connection means cooperating with each other.

### BACKGROUND OF THE INVENTION

The invention relates to a mat, in particular a door mat, which lies in the course of passing individuals. The invention relates in particular to such a mat for use for houses.

Many types of door mats for houses are known. A simple embodiment is the coconut matting. Other examples are the synthetic mat, which may or may not have a profile, and the steel grating.

On the other hand for projects, such as department stores and offices, composite mats are available, which are composed of longitudinal profiles which can be interconnected, in which brushes and the like are incorporated. Such mats are often sunk in a fixed frame which has preliminarly been accommodated in the floor (vide for instance U.S. Pat. No. Re. 32,061), or accommodated in a prefabricated frame which is laid on a floor (vide for instance U.S. Pat. No. 4,029,834).

It is an object of the invention to provide a system mat which is composed of longitudinal profiles having brushes and the like incorporated therein, which is suitable for use for houses.

It is an object of the invention to provide a system mat which is composed of longitudinal profiles having brushes and the like incorporated therein, which is easy to assemble.

It is an object of the invention to provide a system mat which is composed of longitudinal profiles having brushes and the like incorporated therein, which can simply be cut to length in situ.

It is an object of the invention to provide a system mat which is composed of longitudinal profiles having brushes and the like incorporated therein, which has a nice appearance.

### SUMMARY OF THE INVENTION

According to one aspect the invention provides a mat with a tread area for cleaning foot-wear of individuals walking over the mat, comprising a series of longitudinal profiles, formed by extrusion, which are disposed in parallel, which are each provided with an accommodation recess for accommodating a tread area member, such as a brush, furthermore comprising one or more coupling profiles, extending substantially transversely to the longitudinal profiles and comprising first connection means for connection with the longitudinal profiles, wherein two coupling profiles are arranged for respective connection with the longitudinal-ends of the longitudinal profiles, and also comprising confining profiles extending along said two coupling profiles, wherein the two coupling profiles and the associated confining profiles are provided with second and third connection means cooperating with each other.

Thus the transverse side of the frame is formed by confining profiles which can be connected with the coupling profiles, without additional securing means, such as screws, bolts, and the like, including adhering.

When the confining profiles extend over the coupling profiles, the confining profiles also have as a function to hide the rim coupling profiles from view.

Simple assembly is enhanced when the second and third connection means form a snap connection. Then the second connection means may comprise a convex cam at an upper side of a coupling profile for accommodation in a recess at an inner side of a confining profile. As an alternative the inner side of the coupling profile can be provided with a protrusion which is to be accommodated in a recess at the upper side of the coupling profile so as to realize the snap connection.

According to one embodiment the first connection means for fitting accommodation, in particular clamping accommodation, of the longitudinal profiles. Thereby the construction height can remain limited.

According to a further embodiment thereof the coupling profiles are provided with a base strip, onto which coupling bodies are provided which extend upwards therefrom, and which define adjacent accommodation recesses, wherein the coupling bodies are provided with engagement means for engaging the sides and/or the upper side of the accommodated longitudinal profiles. Thus the coupling bodies and longitudinal profiles alternate and they form a continuous series of structural links. Thereby the construction height can also remain limited.

The coupling bodies can be provided with an upper member, onto which the first connection means are provided, by which a relative upward movement of the longitudinal profiles can be effectively prevented. This is even enhanced when the coupling bodies are provided with an upper part which is provided with confining sections, preferably confining brackets, which engage the upper side of the longitudinal profiles.

According to one embodiment the mat furthermore comprises a run-up profile at at least one longitudinal edge of the mat, preferably at both longitudinal edges. The run-up profile or the run-up profiles can form a frame with the coupling profiles and the confining profiles.

According to a further aspect the invention provides a mat with a tread area for cleaning foot-wear of individuals walking over the mat, comprising a series of longitudinal profiles, formed by extrusion, which are disposed in parallel, which are each provided with an accommodation recess for accommodating a tread area member, such as a brush, furthermore comprising one or more coupling profiles, which are substantially transverse to the longitudinal profiles and are each provided with a series of accommodation recesses for accommodating the longitudinal profiles, wherein two coupling profiles are arranged to respectively accommodate the longitudinal ends of the longitudinal profiles, and also comprising confining profiles extending along said two coupling profiles, and also comprising two run-up profiles provided at the longitudinal edges which together with the confining profiles form a frame for the mat.

According to one embodiment the run-up profile is provided with coupling means for coupling with the coupling profiles, in order to facilitate the assembly of the mat.

According to a simple embodiment the coupling means comprise an accommodation recess for a coupling body of the coupling profiles.

Preferably said accommodation recess is similar to the other accommodation recesses of the coupling profile, so that the coupling profile can be cut to length and yet be coupled at its end with the run-up profile.

According to a further embodiment the coupling means comprise a protrusion at the run-up profile which fits in an accommodation recess of the coupling profiles. Thus a coupling in turns between the coupling profile and run-up profile is realized, with the means which are repeatingly formed on the coupling profile.

According to one embodiment the run-up profile comprises a longitudinal accommodation recess for accommodating a decorative profile, so that the run-up profile can be atuned to taste and use.

According to one embodiment the mat is provided with means for reinforcement of the corner between the run-up profile and the coupling profile. Then the run-up profile may comprise an accommodation recess for a corner reinforcement, such as a steel L-strip. Furthermore the coupling profile and the confining profile can be adapted to clamp between them a part of the corner reinforcement, such as a leg of an L-strip.

According to one embodiment the mat is provided with cover caps for covering the longitudinal ends of the run-up profile. In case of the above mentioned corner reinforcement, such as an L-strip, the latter can be provided with a hole and the cover caps are provided with a snap pin for attachment to the corner reinforcement, the L-strip, by which the run-up profile can be confined in its longitudinal direction. The cover caps can also have a function in confining the above mentioned decorative profile/strip in the run-up profile.

According to a simple embodiment at the bottom side the longitudinal profiles are provided with antiskid means.

According to an alternative of additional embodiment at the bottom side the longitudinal profiles are provided with an accommodation recess for a skidproof section.

The longitudinal profiles, the coupling profiles, the tread area members and/or the run-up profiles can be made of material that can be cut to length.

In case of larger lengths one or more further coupling profiles can be arranged between the two coupling profiles which are located at the longitudinal ends.

According to a further aspect the invention provides a mat with a tread area for cleaning foot-wear of individuals walking over the mat, comprising a series of longitudinal profiles, formed by extrusion, which are disposed in parallel, which are each provided with an accommodation recess for accommodating a tread area member, such as a brush, furthermore comprising one or more coupling profiles, which are substantially transverse to the longitudinal profiles and each comprise accommodation recesses for accommodating the longitudinal profiles, wherein two coupling profiles are arranged which respectively accommodate the longitudinal ends of the longitudinal profiles.

According to an embodiment thereof the coupling profiles are provided with a base strip, onto which coupling bodies are provided which extend upwards therefrom, defining adjacent accommodation recesses, wherein the coupling bodies are provided with engagement means for engaging the sides and/or the upper side of the accommodated longitudinal profiles.

It is remarked that from U.S. Pat. No. specification 2,805,437 a mat is known, which is composed of among others a number of longitudinal brush holders with brushes which are kept adjacent to each other by means of a U-shaped central holder with passages for the brush holders, as well as two end holders which are provided with passages for the brush holders. The end holders are provided with an upright end rim, which can be formed integrally with the end holders or can be welded thereto. The brush holders are secured to the holder by bending the lips which define the passages.

German patent application 25 55 125 discloses a mat with longitudinal brush holders which are centrally supported by a strip-shaped holder and which are supported at the ends by strip-shaped end holders, connected therewith by a welding joint. The ends of the brushes and the end holders can be covered by means of an upright strip, which can be attached to the end holders by means of screws or additionally added spring clamps.

According to a further aspect the invention provides a mat with a tread area for cleaning foot-wear of individuals walking over the mat, comprising a series of longitudinal profiles which are disposed in parallel, for accommodating respective tread area members, such as brushes, furthermore comprising one or more coupling profiles, which are substantially transverse to the longitudinal profiles and each comprise first connection means for connection with the longitudinal profiles, wherein two coupling profiles are arranged for respective connection with the longitudinal ends of the longitudinal profiles, and also comprising confining profiles which extend along the two coupling profiles, and which themselves can be attached to the coupling profiles, furthermore comprising at at least one longitudinal edge of the mat a run-up profile, which can be attached to the coupling profile by self-clamping, corner reinforcements for reinforcement of the corners between coupling profiles and run-up profile, wherein the corner reinforcements are locked in-between the confining profiles and the coupling profiles. Such a mat can be assembled without the need of common mechanical connection means, such as screws and bolts, or addition of an adhesive or application of (ultrasonic) welding.

Wherever possibble, the aspects and measures as described in this application can also be applied either individually or in other combinations. Those individual aspects may be the subject of divisional patent applications which are directed thereto.

### SHORT DESCRIPTION OF THE DRAWINGS

The invention will be elucidated on the basis of an exemplary embodiment which is shown in the attached drawings, in which:

FIG. 1 is an exploded view of an exemplary embodiment of a mat according to the invention;

FIG. 2 is a view of the mat of FIG. 1, in assembled condition;

FIGS. 3A and 3B show a run-up profile of the mat of FIGS. 1 and 2, in cross section, with and without a decorative strip, respectively;

FIG. 3C is an alternative embodiment of a run-up profile;

FIGS. 4A and 4B are a cross section through a base profile in the mat of FIGS. 1 and 2, with and without inserts, respectively;

FIG. 4C is a cross section through an alternative embodiment of a base profile;

FIGS. 5A-D show a front view, top view, side view and a detail, respectively, of a coupling profile for the mat of FIGS. 1 and 2;

FIGS. 6, 6A-C show a perspective view, a front view, a side view and a cross section, respectively, of a cover cap for the mat of FIGS. 1 and 2;

FIGS. 7A-J show successive stages in assembling the mat of FIG. 2.

### DETAILED DESCRIPTION OF THE DRAWINGS

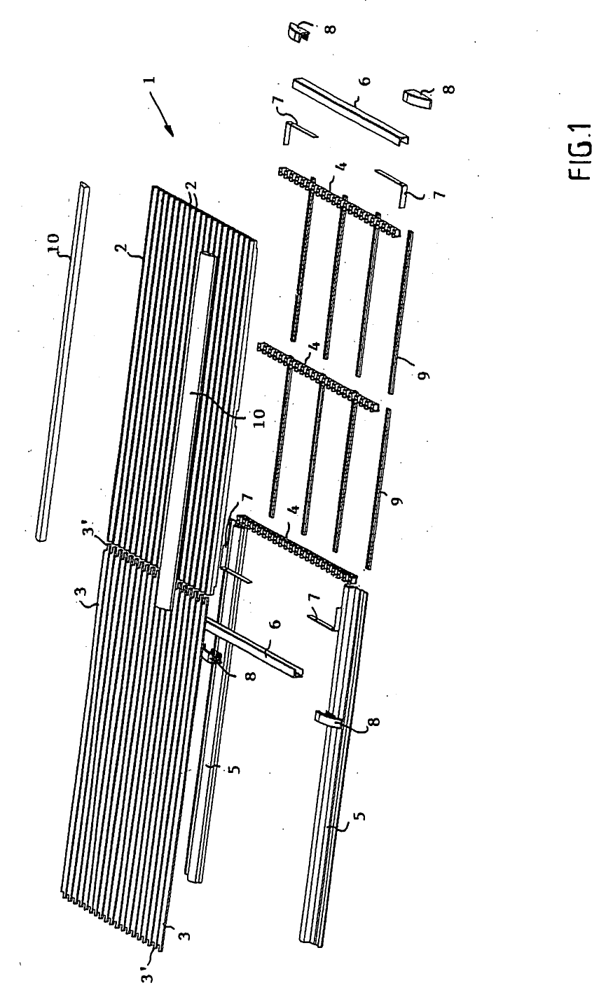

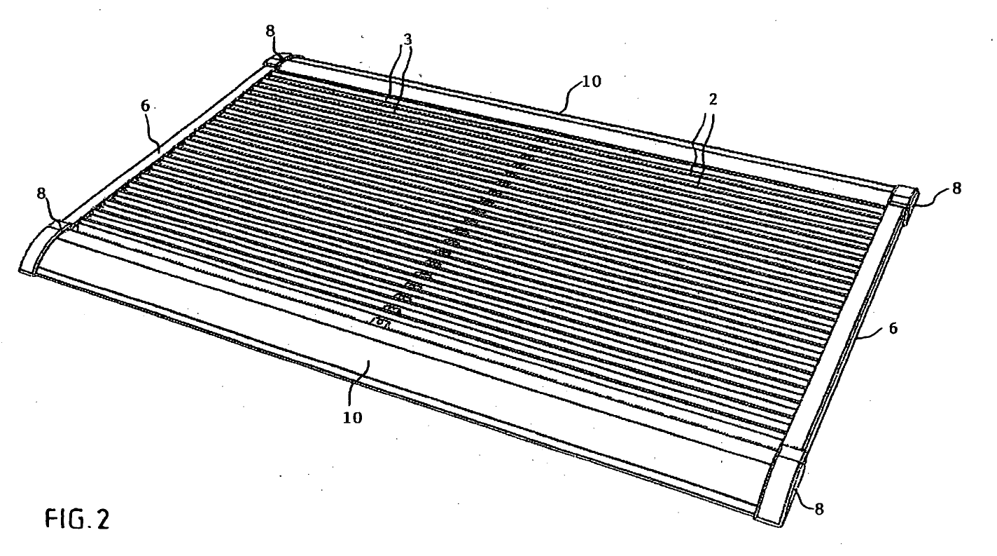

In the exemplary embodiment, illustrated in FIGS. 1 ff., the exemplary mat 1 according to the invention comprises a series of base profiles 2, in which tread area members 3 can be accommodated, a number, three in this case, of coupling profiles 4, in which the base profiles 2 are confined, longitudinally extending cover profiles or run-up profiles 5 in which decorative or buffer strips 10 can be accommodated, corner pieces 7, at each corner of the mat 1, confining profiles 6, at both transverse edges of the mat 1, cover caps 8 at each corner of the mat 1 and, at the bottom side of the base profiles 2, skidproof strips 9.

The base profiles 2, tread area members 3, skidproof profiles 9, run-up profiles 5, decorative strips 10 and confining profiles 6 are made of a material which, at the location where the mat will be used, can be cut to the required length, such as by sawing, cutting and the like. The base profiles 2, run-up profiles 5, decorative strips 10 and confining profiles 6 can be formed by means of extrusion of synthetic material or any other suitable material, for instance aluminium.

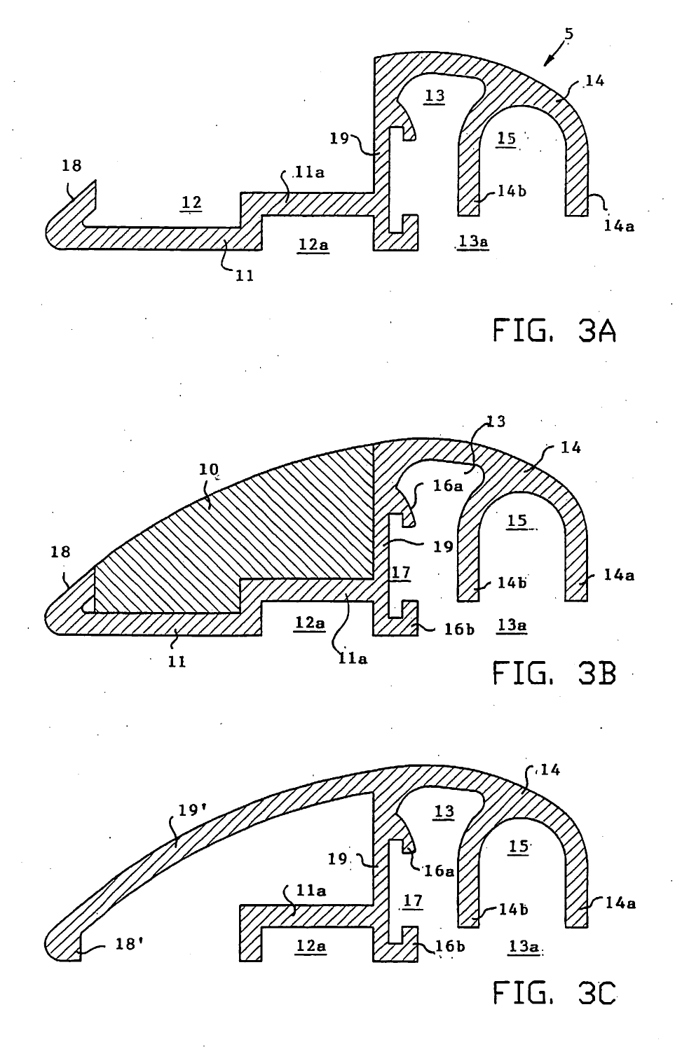

The run-up profile 5, illustrated in FIGS. 3A ff. can for instance be formed of aluminium or PVC, and comprises a base strip 11 to be placed on a base, and above said base strip 11 a confining space 12 is formed for the decorative or buffer strip 10 (FIG. 3B). At the run-up side the recess 12 is bounded by a flanged lip 18. At the side which faces away from it, the accommodation recess 12 is bounded by an upright wall 19, from which a curved wall 14 declines, which slopes down in the vertical leg 14a, which together with a somewhat inwards disposed leg 14b, forms a cavity 15.

Between the leg 14b and the wall 19 another accommodation recess 13 is formed for a coupling body 51 of the coupling profile 4 illustrated in FIGS. 5A ff. Furthermore an accommodation recess 17 is formed at the wall 19, bounded by longitudinal ribs 16a and 16b. The base strip 11 has an elevated section 11a, beneath which a cavity 12a is formed. Underneath the legs 14a, 14b a recess 13a has been left.

In the alternative example of FIG. 3C no accommodation recess 12 is formed, but the lip 18 is continued so as to converge to the curved upper wall 14′. By means of the support rim 18′ the run-up profile 5′ can bear on a ground.

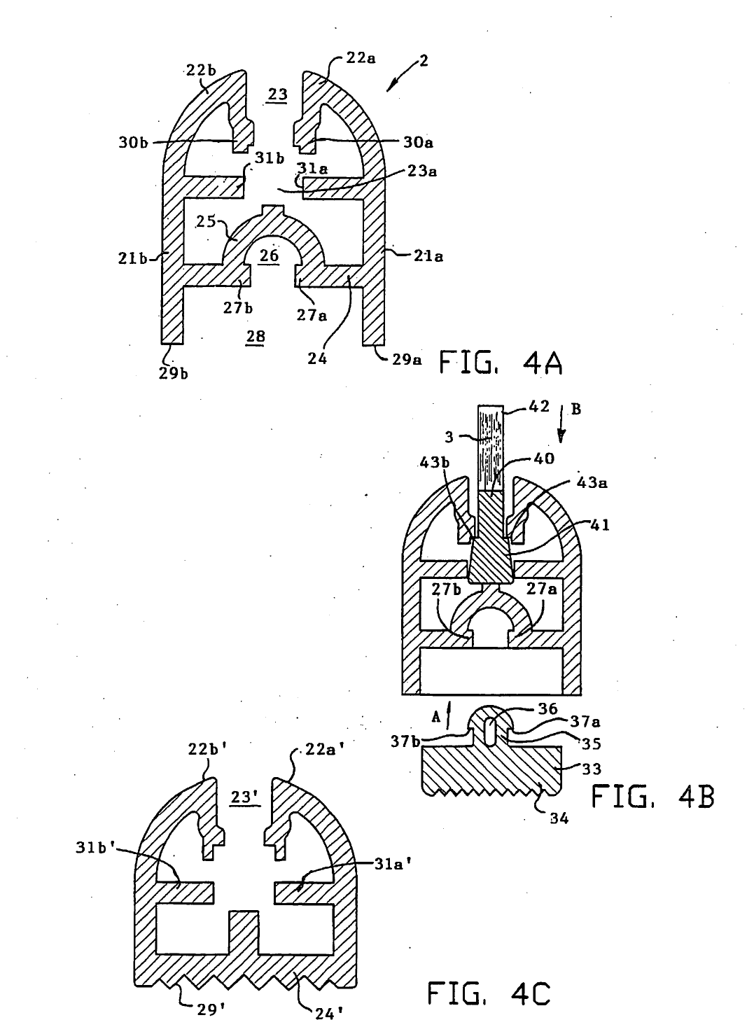

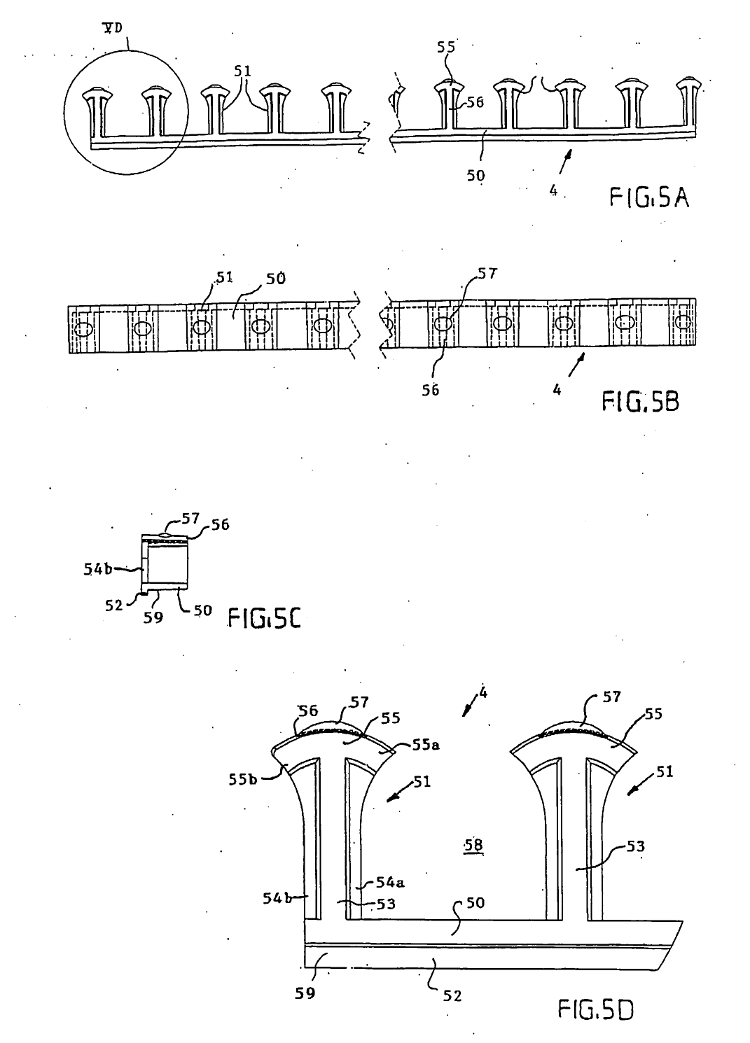

In this example the base strip 2, illustrated in FIG. 4A, is formed, by extrusion, of aluminium or PVC and comprises a body 20, with side walls 21a and 21b. The side walls 21a and 21b converge upwards to curved upper wall members 22a, 22b, which terminate at a distance from each other so as to leave a slot 23. The slot 23 is bounded downwards by sloping walls 30a, 30b, which terminate at a distance above walls 31a, 31b which extend towards each other transversely to the walls 21a, 21b. Underneath, between the walls 21a, 21b a transverse wall 24 is formed, which comprises a circularly curved wall member 25, which extends upwards and which is provided with a rib 32. Above the rib 32, bounded sidewards by the walls 31a, 31b and obliquely upwards through the walls 30a, 30b an accommodation recess 23a is realized, which converges upwards to the slot 23.

Beneath the curved wall 25 an accommodation recess 26 is formed, which is bounded dowards by ribs 27a, 27b, below which an accommodation recess 28 is located. At their bottom end the walls 21a, 21b are provided with support surfaces 29a, 29b.

In FIG. 4B the base profile 2 is provided with/has a skidproof strip 33 and a scraper strip or brush strip 3, as an embodiment of a tread area member.

The skidproof strip 33 comprises a skidproof lower surface 34 and at the upper side it comprises a fastening rib 35, which comprises a cavity 36 for impression-flexibility. At both sides snap cams 37a, 37b are provided. When leading the skidproof strip 33 in the direction A into the bottom side of the base strip 2, snap cams 37a, 37b can be moved towards each other as a consequence of the cavity 36, at a force which is excerted by the ribs 27a, 27b. Once the cams 37a, 37b have arrived above 27a, 27b, they snap tight thereover, and the skidproof strip 33 has been fixed in the accommodation recess 28.

The brush strip 3 comprises a strip-shaped base member 40, with a thicker lower end 41 which comprises shoulders 43a, 43b. On top of the base strip 40 brush hairs 42 are provided. After placing the brushes 40 in the direction B in the slot 23 and the accommodation recess 23a the broadened member 41 is confined between the rib 32, the walls 31a, 31b, and the walls 30a, 30b, as illustrated in FIG. 4B. At the ends 3′ the brush strip 3 has no brush hairs 42.

The base strip 2′ as illustrated in FIG. 4C has been embodied more simply, wherein the transverse wall 24′ now defines the bottom surface with the corrugated profile 29′. Then a separate skidproof profile is not necessary. Again at the upper side, as in the base profile 2 of FIG. 4A, an accommodation recess 23′, 23a′ is formed, as illustrated.

The coupling profile 4, illustrated in FIGS. 5A-D, can be formed by die casting, of a synthetic material, for instance polypropene. The coupling profile 4 comprises a base strip 50, wherein at one longitudinal edge thereof a downwards sloping abutment rib 52 is formed, which forms a recess 59 together with the strip 50. At regular intervals coupling bodies 51 are moulded at the upper side of the base strip 50, with an upright body 53 and at the side of the edge 52 upright reinforcement ribs 54a, 54b which are transverse to the bodies 53. Between the coupling bodies 51 accommodation recesses 58 have been left. The reinforcement ribs 54a, 54b and the body 53 converge upwards to an upper wall 55, which has a convex upper surface 56 with wall members 55a, 55b which are curved downards to both sides, which define the shape of a T with the body 53. The edges of the reinforcing ribs 54a, 54b which are directed towards the accommodation recess 58, and the downwards curved wall members 55a, 55b define a contour of the accommodation recess 58, the shape of which corresponds with the outer contour of the walls 21a, 21b, 22a, 22b, 22a′, 22b′ of the base profiles 2 as illustrated in FIGS. 4A-C. A cam 57 is moulded at the upper surface 56 of the wall 55.

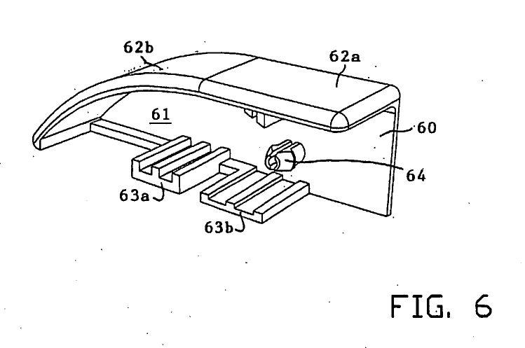

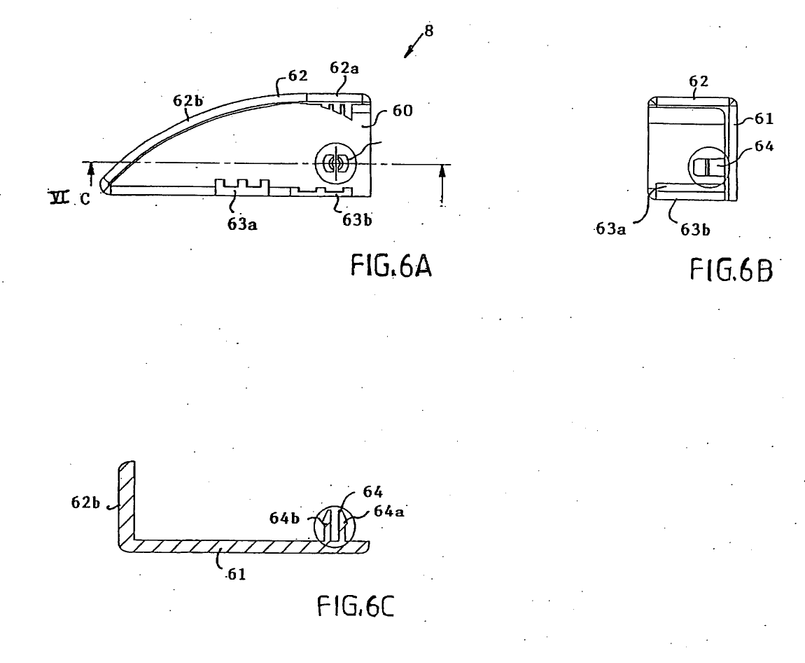

In FIGS. 6A-C one of the two embodiments of the cover caps 8 is illustrated. It is suitable for two of the corners of the mat 1. For the other corners a similar cover cap 8 will be used, but in a reflected embodiment.

The cover cap 8 comprises a synthetic body 60, for instance formed by die casting of for instance aluminium, ABS or polypropene. The body 60 comprises a vertical wall 61 and a largely curved upper wall 62, with a flat end part 62a and a curved section 62b. Support plates 63a, 63b extend from the bottom edge of the upright wall 61, which comprise profiled sections at the upper surface. A snap pin 64 extends transversely from the wall 61, and in this example it comprises two snap brackets 64a, 64b.

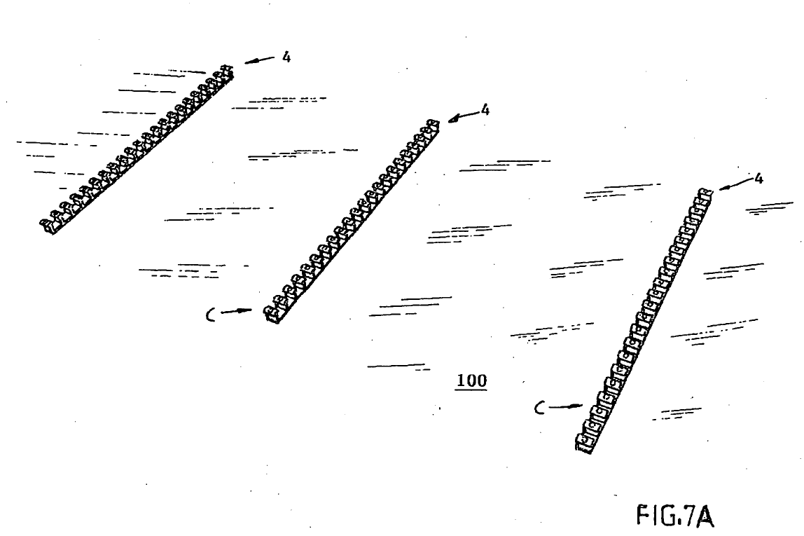

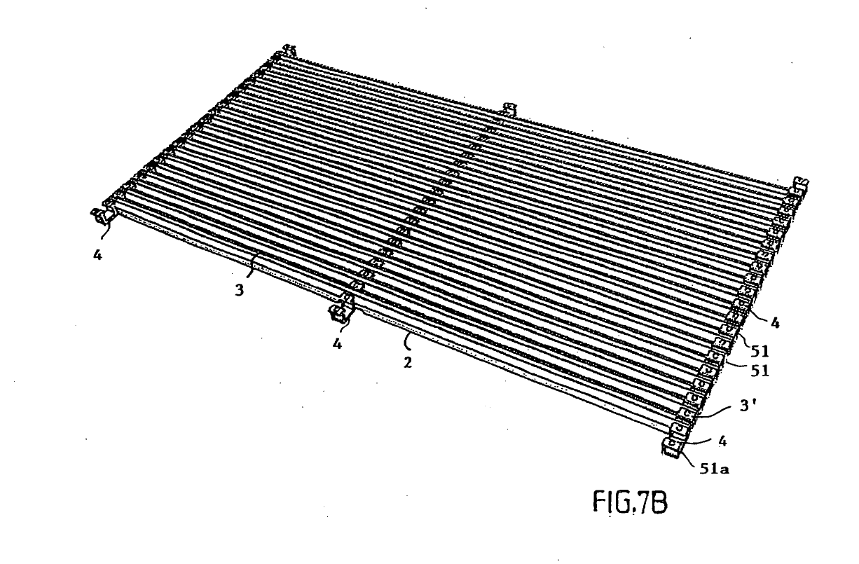

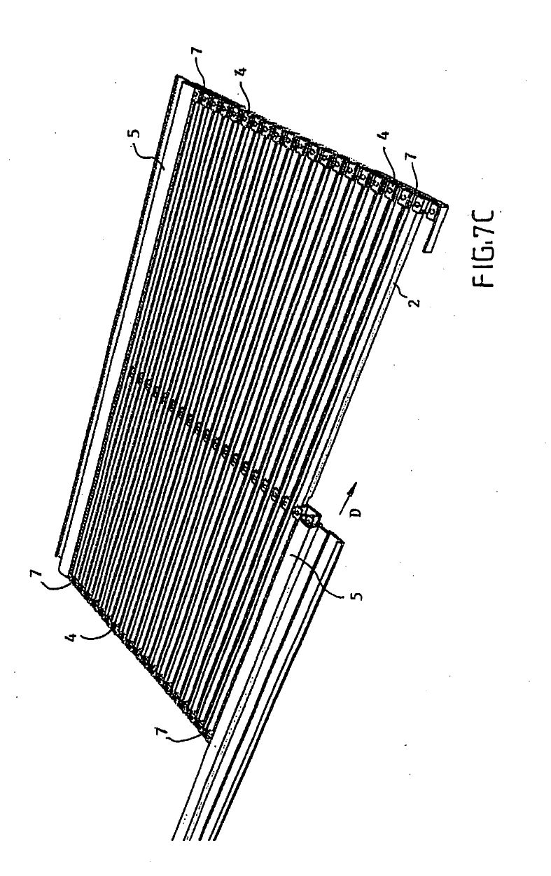

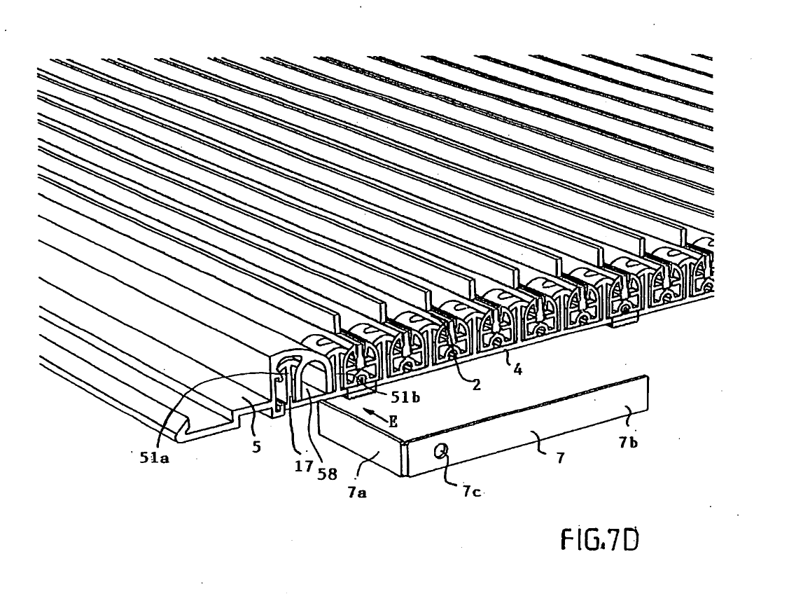

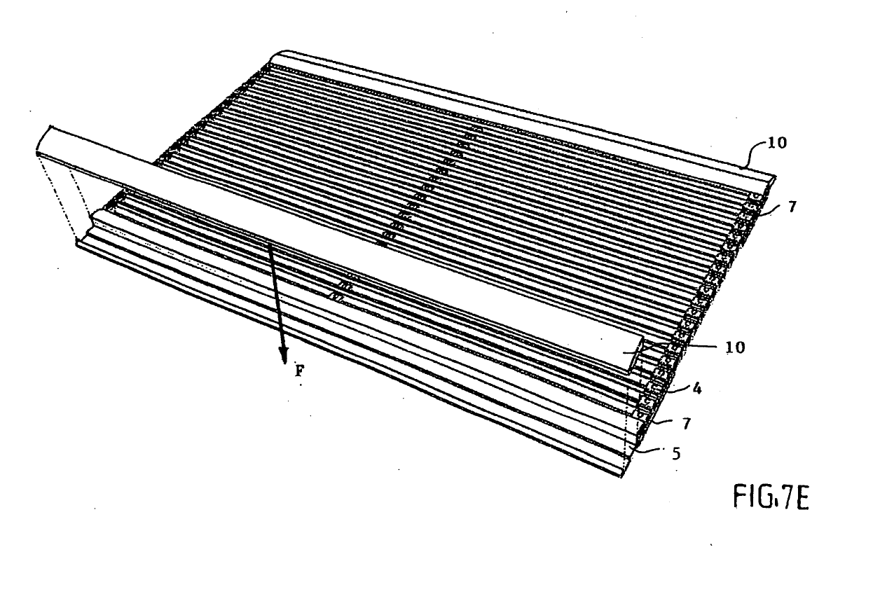

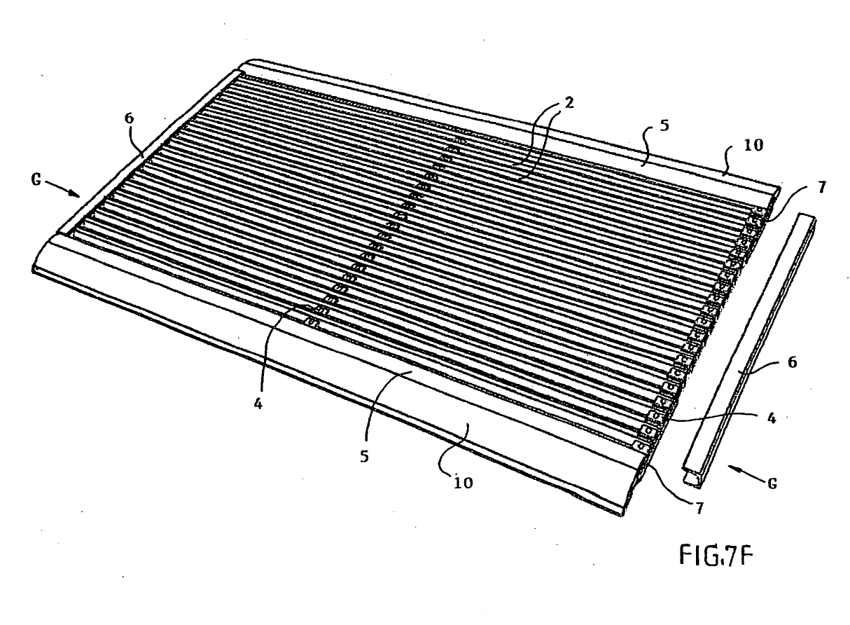

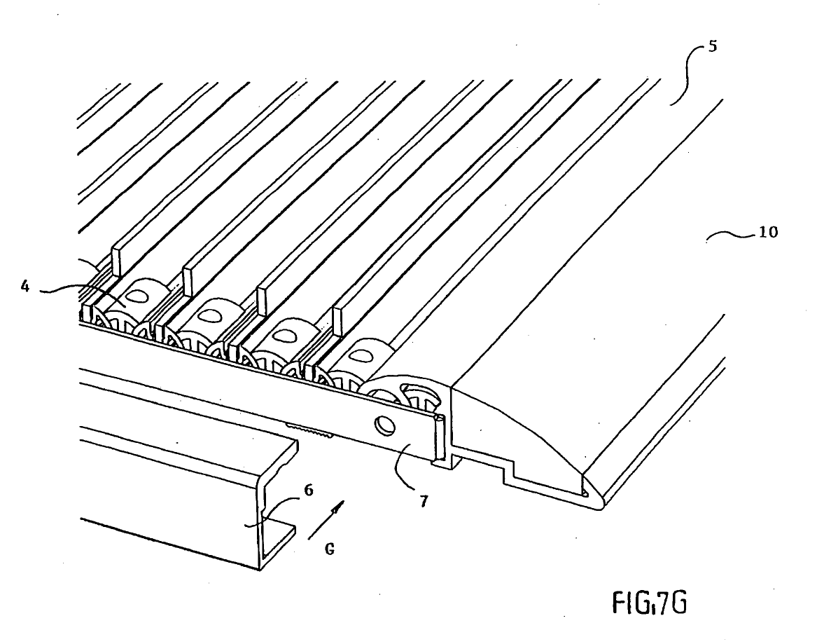

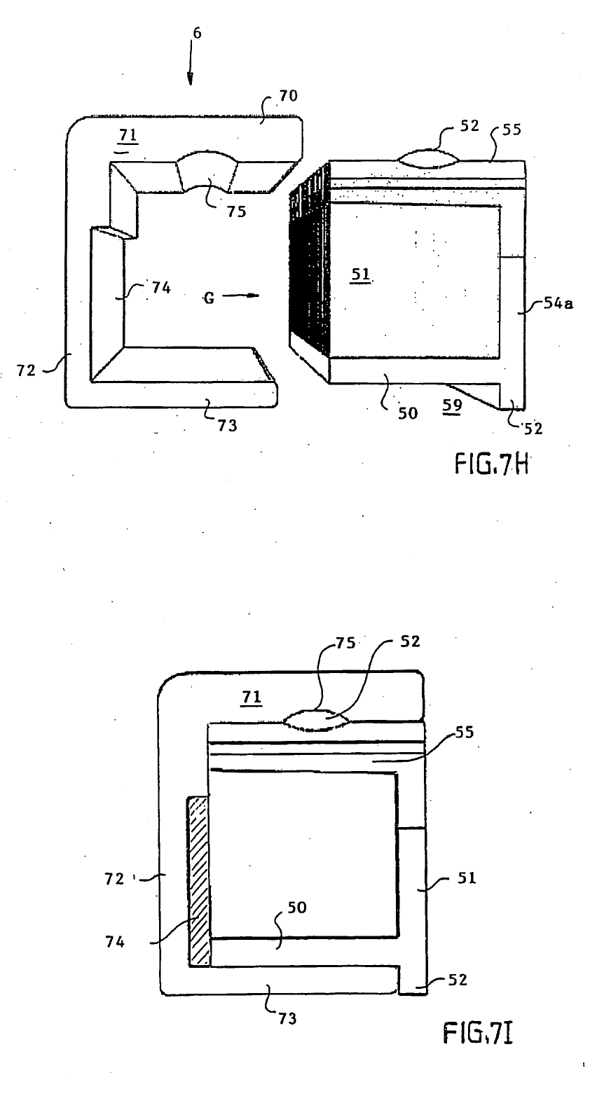

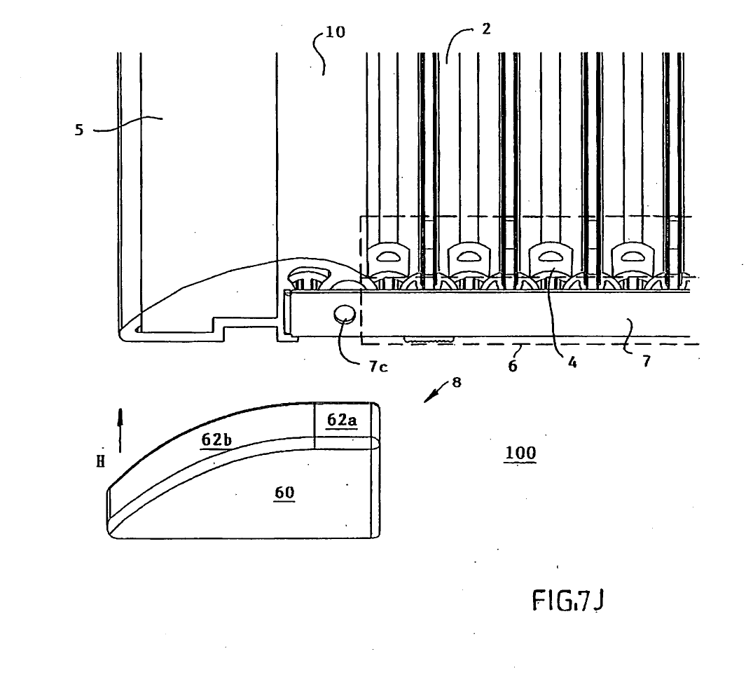

Furthermore four angle irons 7 also belong to the assembly of the mat 1, vide also in particular FIG. 7D. They are L-shaped, with a leg 7a and a leg 7b. A hole 7c is formed in the leg 7b, with which the snap pin 64 can cooperate in a snapping manner.

The mat 1 furthermore comprises confining profiles 6, further illustrated in FIG. 7H, at the left. The defining profile 6 can be made by extrusion, of synthetic material, for instance polypropene or PVC. It is a substantially U-shaped body 70, with an upper wall 71, a side wall 72, and a bottom wall 73. In the upper wall 71, at the bottom side thereof, a snap slot 75 is formed, which can cooperate with the cams 57 on the coupling profiles 4 for snap-action. In the side wall 72 a slot 74 is left, to accommodate the leg 7b of the angle iron 7.

With reference to FIG. 7A ff. the assembly of the mat 1 will now be elucidated.

After having determined the required dimensions and after having brought the various profiles-to length, the coupling profiles 4 are placed on a ground 100. In this example an additional coupling profile 4 can be laid between the two edge-coupling profiles 4.

Subsequently the base profiles 2 are shifted in the direction C (which may or may not already have been provided with antiskid profiles 30, in a manner as illustrated in FIG. 4B) into the accommodation recesses 58 of the coupling profiles 4, wherein the longitudinal ends thereof are accommodated between the upright reinforcement ribs 54a, 54b and the downwards curved wall members 55a, 55b. Then finally the situation is obtained as illustrated in FIG. 7B. Here the edges of the curved upper wall members 55a, 55b push against the curved upper wall members 22a, 22b of the base profiles 2, so that at that location the base profiles 2 are clampingly and tightly retained by the coupling profiles 4. The wall members 55a, 55b can be somewhat resilient, for a permanent grip, also on the long term. When placing the run-up profile 5, the coupling body 51a which is located at the end of the coupling profile 4, fits clampingly in the accommodation recess 13 of the run-up profile 5. Here the legs 14a and 14b extend between two adjacent coupling bodies 51a, b (FIG. 7D) in the accommodation recess 58 which is defined therebetween.

As is also illustrated in FIG. 7D, the angle steels 7 are then inserted at the four corners, with the leg 7a in a friction fit in the slot 17, provided for that purpose, in the run-up profile 5. Then the hole 7c is located in front of the recess 15.

Furthermore, as illustrated in FIG. 7E, the buffer strips 10 are placed (direction F) in the accommodation recesses 12 of the run-up profiles 5.

Then the confining profiles 6 are placed, as illustrated in FIG. 7F. As illustrated in FIG. 7H the confining profiles 6 are shifted in the direction G over and under the coupling profiles 4, wherein the bottom wall 73 fits in the recess 59 and with the edge it abuts against the abutment edge 52 at the coupling profiles 4 and the snap cams 57 snap in the slot 75 at the bottom side of the upper wall 71 of the confining profile 6. The bottom side of the wall 73 is aligned with the bottom side of the bottom edge 52.

Then the leg 7b of the angle iron 7 is also accommodated in the slot 74 in the wall 72. Finally said members fit together, as illustrated in FIG. 71.

Then the angle iron 7 is secured at its location, as well as the run-up profiles 5. Then the angle irons ensure a reinforcement of the corners of the mat 1.

Finally the cover caps 8 are placed, wherein the snap-pins snap in holes 7c, and extend further into the recess 15. Support plate 63a then extends into the cavity 12a and the support plate 63b extends into the cavity 13a. Then the upper wall 62 ensures upward confinement of the buffer strip 10 in the accommodation recess 12.

Then the mat 1 is ready, in the configuration as illustrated in FIG. 2. The upper walls 71 of the confining profiles 6 cover the upper side of the coupling profiles 4, and extend over the ends of the brush strip 3′, up to the brush hairs 42.

Thus the mat 1 has been assembled without using additional securing means, such as screws and bolts, or by using an adhesive. Thereby the mat can be easily assembled in situ, for which at most a saw or the like is needed in order to bring the profiles at the required length. The mat 1 is selfconnected, and is reinforced against deformation in its plane.

1. Mat with a tread area for cleaning foot-wear of individuals walking over the mat, comprising a series of longitudinal profiles, formed by extrusion, which are disposed in parallel, which are each provided with an accommodation recess for accommodating a tread area member, such as a brush, furthermore comprising one or more coupling profiles, extending substantially transversely to the longitudinal profiles and comprising first connection means for connection with the longitudinal profiles, wherein two coupling profiles are arranged for respective connection with the longitudinal ends of the longitudinal profiles, and also comprising confining profiles extending along said two coupling profiles, wherein the two coupling profiles and the associated confining profiles are provided with second and third connection means cooperating with each other.

2. Mat according to claim 1, wherein the confining profiles extend over the coupling profiles.

3. Mat according to claim 1, wherein the first connection means form accommodation recesses for the longitudinal profiles.

4. Mat according to claim 1, wherein the second and third connection means form a snap connection, wherein preferably the second connection means comprise at an upper side of a coupling profile a convex cam which is to be accommodated in a recess at an inner side of a confining profile.

5. Profile according to claim 2, wherein the first connection means form accommodating recesses for the longitudinal profiles, and wherein the coupling profiles are provided with a base strip, onto which coupling bodies are provided which extend upwards therefrom, and which define adjacent accommodation recesses, wherein the coupling bodies are provided with engagement means for engaging, particularly clamping, the sides and/or the upper side of the accommodated longitudinal profiles.

6. Mat according to claim 5, wherein the coupling bodies are provided with an upper part, on which the first connection means are provided.

7. Mat according to claim 5, wherein the coupling bodies are provided with an upper part which is provided with confining sections, preferably confining brackets, which engage the upper side of the longitudinal profiles.

8. Mat according to claim 1, wherein at the bottom side the longitudinal profiles are provided with an accommodation recess for a skidproof section.

9. Mat according to claim 1, furthermore provided with a run-up profile at at least one longitudinal edge of the mat.

10. Mat with a tread area for cleaning foot-wear of individuals walking over the mat, comprising a series of longitudinal profiles, formed by extrusion, which are disposed in parallel, which are each provided with an accommodation recess for accommodating a tread area member, such as a brush, furthermore comprising one or more coupling profiles, which are substantially transverse to the longitudinal profiles and are each provided with a series of accommodation recesses for accommodating the longitudinal profiles, wherein two coupling profiles are arranged to respectively accommodate the longitudinal ends of the longitudinal profiles, and also comprising confining profiles extending along said two coupling profiles for accommodating the coupling profiles, and also comprising two run-up profiles provided at the longitudinal edges which together with the confining profiles form a frame for the mat.

11. Mat according to claim 10, wherein the run-up profile is provided with coupling means for coupling with the coupling profiles.

12. Mat according to claim 11, wherein the first connection means form accommodating recesses for the longitudinal profiles, and wherein the coupling profiles are provided with a base strip, onto which coupling bodies are provided which extend upwards therefrom, and which define adjacent accommodation recesses, wherein the coupling bodies are provided with engagement means for engaging, particularly clamping, the sides and/or the upper side of the accommodated longitudinal profiles, wherein the coupling means comprise an, accommodation recess for a coupling body of the coupling profiles, which is preferably similar to the other accommodation recesses of the coupling profile.

13. Mat according to claim 11, wherein the coupling means comprise a protrusion at the run-up profile which fits in an accommodation recess of the coupling profiles.

14. Mat according to claim 10, wherein the run-up profile comprises a longitudinal accommodation recess for accommodating a decorative profile.

15. Mat according to claim 10, comprising means for reinforcement of the corner between the run-up profile and the coupling profile.

16. Mat according to claim 15, wherein the run-up profile comprises an accommodation recess for a corner reinforcement, such as a steel L-strip

17. Mat according to claim 15, wherein the coupling profile and the confining profile are adapted to clamp between them a part of the corner reinforcement, such as a leg of an L-strip.

18. Mat according to claim 10, furthermore provided with cover caps for covering the longitudinal ends of the run-up profile.

19. Mat according to claim 16, furtherrmore provided with cover caps for covering the longitudinal ends of the run-up profile, wherein the L-strip is provided with a hole and the cover caps are provided with a snap pin for attachment to the L-strip.

20. Mat according to claim 1, wherein the confining profiles extend over the coupling profiles.

21. Mat according to claim 10, wherein-the confining profiles extend over the coupling profiles.

22. Mat according to claim 1, wherein the longitudinal profiles, the coupling profiles, the tread area members and/or the run-up profiles are made of material that can be cut to length.

23. Mat according to claim 1, wherein one or more further coupling profiles are arranged between the two coupling profiles which are located at the longitudinal ends.

24. Mat with a tread area for cleaning foot-wear of individuals walking over the mat, comprising a series of longitudinal profiles, formed by extrusion, which are disposed in parallel, which are each provided with an accommodation recess for accommodating a tread area member, such as a brush, furthermore comprising one or more coupling profiles, which are substantially transverse to the longitudinal profiles and each comprise accommodation recesses for fitting accommodation of the longitudinal profiles, wherein two coupling profiles are arranged which respectively accommodate the longitudinal ends of the longitudinal profiles.

25. Mat according to claim 23, wherein the coupling profiles are provided with a base strip, onto which coupling bodies are provided which extend upwards therefrom, defining adjacent accommodation recesses, wherein the coupling bodies are provided with engagement means for engaging the sides and/or the upper side of the accommodated longitudinal profiles.

26. Mat with a tread area for cleaning foot-wear of individuals walking over the mat, comprising a series of longitudinal profiles which are disposed in parallel, for holding respective tread area members, such as brushes, furthermore comprising one or more coupling profiles, which are substantially transverse to the longitudinal profiles and each comprise first connection means for connection with the longitudinal profiles, wherein two coupling profiles are arranged for respective connection with the longitudinal ends of the longitudinal profiles, and also comprising confining profiles which extend along the two coupling profiles, and which themselves can be attached to the coupling profiles, furthermore comprising at at least one longitudinal edge of the mat a run-up profile, which can be attached to the coupling profile by self-clamping, corner reinforcements for reinforcement of the corners between coupling profiles and run-up profile, wherein the corner reinforcements are locked in-between the confining profiles and the coupling profiles.
